(19) United States
(12) Patent Application Publication
(10) Pub. No.: US 2007/0203733 A1
(43) Pub. Date: Aug. 30, 2007

(54) PROTECTED QUOTE FINDER

(75) Inventor: Christopher KELLEY, Brooklyn, NY (US)

Correspondence Address: SUGHRUE MION, PLLC, 2100 PENNSYLVANIA AVENUE, N.W., SUITE 800, WASHINGTON, DC, 20037, US

(73) Assignee: Royalblue Financial Corporation, New York, NY (US)

(21) Appl. No.: 11/678,944

(22) Filed: Feb. 26, 2007

Related U.S. Application Data
(60) Provisional application No. 60/776,226, filed on Feb. 24, 2006.

(51) Int. Cl. G06Q 10/00; G06Q 30/00

(52) U.S. Cl. 705/1

(57) ABSTRACT

A method of automatically finding a market venue for a limit order, including identifying which of a plurality of market venues on a list of potential routing destinations would offer an order protection from trade-through. Moreover, if at least two of the market venues would offer the order protection from trade-through, the method may further include selecting a protecting market venue, from among the market venues that would offer the order protection from trade-through, based on one or more criteria. If none of the market venues would offer the order protection from trade-through, the method may further include selecting a non-protecting market venue from the list of potential routing destinations based on one or more criteria.

This application claims benefit from U.S. Provisional Application No. 60/776,226, filed on Feb. 24, 2006, the entire disclosure of which is herein incorporated by reference.

### FIELD OF INVENTION

Methods consistent with this invention generally relate to electronic trading of financial instruments and, more specifically, to allowing market participants to automatically identify and place an order on a market venue where the order will represent a protected quote on that market venue, i.e., the order will be protected from trade-through on that market.

### BACKGROUND OF THE INVENTION

The U.S. equities markets offer participants the ability to display trading interest on a variety of market execution venues, including exchanges, ECNs and the NASDAQ stock market (which itself is in the process of becoming an exchange). Participants typically display their interest through the use of limit orders, which represent a desire to buy or sell stock, typically a specific quantity of stock, at a stated price.

Participants typically decide which market venue to utilize to post an order to buy or sell stocks based on several factors such as fees, rebates and established business relationships, etc..

As part of its Regulation NMS initiative designed to modernize and strengthen the National Market System (NMS) for equity securities, the Securities and Exchange Commission (SEC) is introducing Rule 611, which will prohibit “trade-throughs” in all NMS securities, which include all exchange-listed and NASDAQ equity securities.

A ‘trade-through’ is generally deemed to have occurred when a market participant effects a trade at a price that is inferior to the price of a quotation already being displayed.

Broadly speaking, Rule 611 prohibits the practice of trading through by any market participant. However, Rule 611 is subject to numerous conditions and exceptions.

Importantly, only certain quotes are subject to protection from trading through under Rule 611. These protected quotes include only the best bid and offer of each trading center, where a trading center may be any national securities exchange (including the NASDAQ stock market, which is as of this writing finalizing its transition to become a national securities exchange), or the Alternative Display Facility(ADF). These are referred to herein as the “protected trading centers.”

Each trading center therefore is endowed with a single protected quote. The quote is two-sided in nature, such each trading center has both a protected bid quote (representing buying interest) and a protected offer quote (representing selling interest).

Each venue where a market participant might choose to display a given limit order is typically associated with one of these protected trading centers, such that the order will in certain circumstances represent all or part of one side of that trading center's protected quote. However, the correspondence between a venue and a protected trading center may vary.

The correspondence may be such that the venue and protected trading center are one and the same, as in the simple case where a market participant who is a member of a national securities exchange sends an order to that exchange.

In other cases, the correspondence is indirect, as when a market participant sends a trade to an ECN or ATS that is affiliated with a national securities exchange, such that the ECN or ATS sends its best bid and offer to that exchange, where it may form all or part of one or both sides of that exchange's protected quote.

The Alternative Display Facility (ADF) represents a third type of correspondence. The ADF offers a quoting mechanism for venues that are not affiliated with a national securities exchange or NASDAQ. However, the ADF's protected bid and offer for a given security are each attributed only to a single ADF participant at a given time, even if multiple participants are quoting at the ADF's best price.

In all of these cases, it is possible to determine whether an order to buy or sell shares in a given quantity at a given limit price would, if transmitted to a particular venue, represent all of part of the protected quote of a protected trading center (for purposes of this document, such orders are considered to be themselves “protected”). The specific logic will vary from venue to venue, but will generally be based the order's limit price (and, in some cases, its share quantity), the nature of the correspondence between the venue and one (or more) protected trading centers, and current quotation data from the relevant trading center(s).

Because protected quotes are the only quotes that other market participants are enjoined from trading through under the provisions of Rule 611, there is an advantage associated with this protected status. In some cases, a market participant may regard the benefit of a protected order to be an important factor in choosing the market venue on which to display the order.

Therefore, it may be beneficial for automated order routing systems to consider whether an order would be protected if routed to a given venue as one factor when making a routing decision from among a multitude of potential venues. Such systems would likely consider additional criteria as well, notably in instances where more than one venue offers an order quote protection, as well as in instances where no venue offers an order quote protection.

An order that is protected on a given venue at the time it is routed to that venue may cease to be protected at a later point in time. This occurs most commonly when the relevant protected trading center receives one or more orders at superior prices (though it may occur in other circumstances as well, notably if the order is placed with a venue that participates in the ADF).

In addition, a venue which was deemed unsuitable for a given order because it did not offer protection to the order may come to offer protection to the order at a later time while the order is still active and residing on a venue which did offer protection (and may continue to offer protection). In such circumstances, it may be desirable to re-route the order to the venue that was originally bypassed.

For both of these reasons, it may be useful to implement a dynamic evaluation of changes to the trade-through protection offered to an order by various venues over the order's life, such that an order may be re-routed from time to time when trade-through circumstances change with respect to the order.

### SUMMARY OF THE INVENTION

One aspect of the invention is directed to a method of automatically selecting a market venue for a limit order, including identifying which of a plurality of market venues on a list of potential routing destinations would offer the order protection from trade-through, and which would not.

Moreover, if at least two of the market venues would offer the order protection from trade-through, the method may include selecting a protecting market venue, from among the market venues that would offer the order protection from trade-through, based on one or more criteria. This may entail choosing among the venues offering protection based on a list ranking the venues in order of preference, or more complex criteria (for example, based on order attributes, market conditions, etc.) may be used.

Furthermore, if none of the market venues offers the order protection from trade-through, the method may include choosing a non-protecting market venue based on one or more additional criteria. This may entail choosing among the venues based on a list ranking the venues in order of preference, or more complex criteria (based on order attributes, market conditions, etc.) may be used. One such criterion would be an evaluation of the venue(s) on which an order is likely to become protected soonest.

The invention may include a mechanism for placing the order with the chosen market venue. Alternatively, the invention may instead interface with such a mechanism.

According to a second aspect of the invention, the method of the invention is provided as instructions of a computer readable medium.

### BRIEF DESCRIPTION OF THE DRAWINGS

The above and other features of the present invention will become more apparent by describing in detail following exemplary embodiments thereof with reference to the attached drawings in which:

FIG. 1 is an exemplary flowchart illustrating a Protecting Venue List Compiler according to an exemplary embodiment of the invention;

FIG. 2 is an exemplary flowchart illustrating a Venue Picker according to an exemplary embodiment of the invention;

FIG. 3 is an exemplary flowchart illustrating generic examples of continuous processing according to an exemplary embodiment of the invention;

FIG. 4 is an exemplary flowchart illustrating an example of a Venue Picker with a more specific example of secondary criteria according to an exemplary embodiment of the invention; and

FIG. 5 is an exemplary flowchart illustrating a more specific example of continuous processing according to an exemplary embodiment of the invention.

### DETAILED DESCRIPTION OF THE EXEMPLARY EMBODIMENTS

While the invention is open to various modifications and alternative forms, exemplary embodiments thereof are shown by way of the drawings and described in detail herein. There is no intent to limit the invention to the particular forms disclosed.

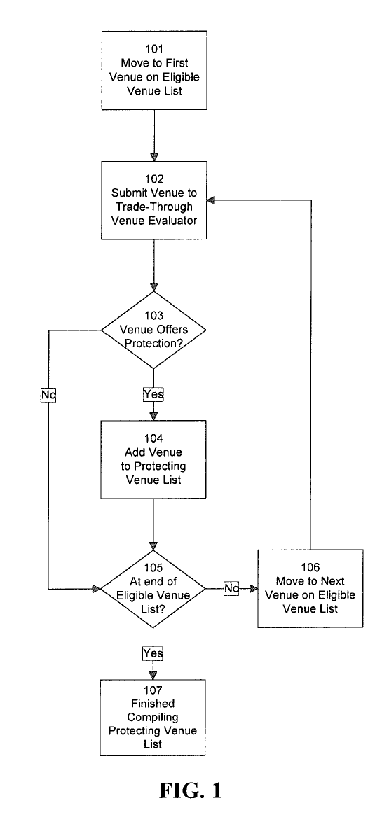

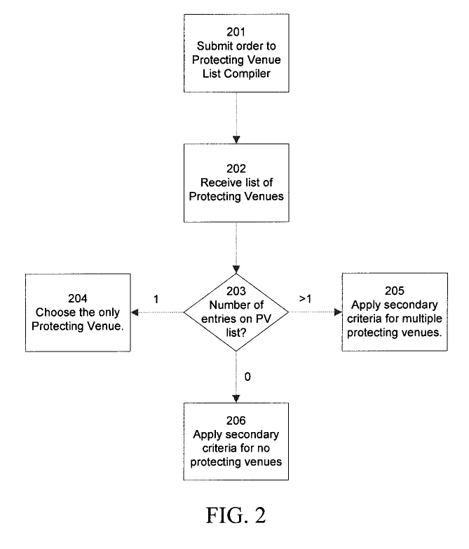

FIGS. 1 and 2 show a Protecting Venue Compiler List (PVLC) and Venue Picker according to an exemplary embodiment of the invention. The PVLC produces a list of venues currently offering tradethrough protection for a given order, while the Venue Picker receives a list of venues offering protection from trade-through from the PVLC and uses a generic secondary criteria to choose a venue in cases where multiple venues offer protection, as well as in cases where no venues offer protection.

FIG. 1 is an exemplary flowchart illustrating a PVLC of this exemplary embodiment of the invention. The PVLC is able to determine all of the venues on which a given order would be protected from trade-through. The PVLC can be provided by software, but the invention is not limited in this respect.

Once the details of a given order have been submitted to the PVLC for evaluation, the PVLC examines all venues from a list of eligible venues (referred to hereafter as the Eligible Venues List). The Eligible Venues List may include all venues that can potentially offer protection to an order, or may be filtered to exclude certain venues based on various criteria. The PVLC determines which of the venues on the Eligible Venues list currently offers the order protection from trade-through (if any), and adds all such venues (hereafter referred to as the Protecting Venues) to a list (hereafter referred to as the Protecting Venues List).

To accomplish this, the PVLC first moves to the first venue on the Eligible Venues List (101). This venue is then submitted to a Trade-Through Venue Evaluator to determine whether the venue offers the order protection from trade-through (102).

In order to make this determination (103), the Trade-Through Venue Evaluator evaluates the order's attributes, along with current conditions regarding quotations associated with the trading center associated with the relevant venue, in order to determine whether the venue offers the order protection from trade-through. As discussed earlier, the logic by which this is determined may vary from one venue and/or associated trading center to another.

Generally speaking, an order will be protected on a given venue if the price of the order matches or improves the best price currently displayed on the trading center associated with that venue. For a buy order to be protected, its price must be equal to or higher than the relevant trading center's best bid price. For a sell order to be protected, its price must be equal to or lower than the relevant trading center's best offer price.

There may be exceptions to this logic for particular trading centers. In particular, the ADF represents such an exception. If an order is to be routed to a venue that is an ADF participant, the routing action must cause that ADF participant's quote to become either: i) the single best-priced quote among all ADF participants for that side of the market in the relevant stock; or ii) the largest-sized quote among all ADF participants quoting at the ADF's overall best price for that side of the market in the relevant stock. Moreover, this logic, or that associated with any other trading center, may change in the future.

The Trade-Through Venue Evaluator is aware of all such logic with respect to all trading centers corresponding to venues appearing on the Eligible Venues List. Further, the Trade-Through Venue Evaluator has continuous access to the current best bid and offer quotation prices for all such trading centers, as well as best bid and offer quotation prices and share quantities for each individual participant on the ADF.

The Trade-Through Venue Evaluator is therefore able to determine, for each venue on the Eligible Venues List, whether that venue currently offers trade-through protection to an order that is being evaluated.

If the venue is deemed to offer trade-through protection to the order, the venue is added to the Protecting Venue List (104).

If the PVLC has not yet reached the end of the Eligible Venue List (105), it moves to the next venue on the Eligible Venue List (106).

The evaluation (103) is then performed with respect to this next venue, which is also added to the Protecting Venue List (104) if it is deemed to offer protection.

This process is repeated for each venue on the Eligible Venue List. Once the end of the Eligible Venue List is reached (107) such that all venues have been evaluated, the PVLC has concluded its processing and the Protecting Venue List is complete.

FIG. 2 is an exemplary flowchart illustrating the basic operation of the Venue Picker according to the exemplary embodiment of the invention. The Venue Picker is used to identify a single venue as the venue to which an order should be sent. The Venue Picker uses a Protecting Venue List Compiler to identify all venues (if any) that offer the order protection from trade-through. It further applies additional criteria in cases where multiple venues offer such protection, as well as in cases where no venues offer such protection, in order to choose a single venue for the order. The Venue Picker can be provided by software, but the invention is not limited in this respect.

The Venue Picker first submits the order to the Protecting Venue List Compiler (201), and receives a Protecting Venues List in response (202).

The Venue Picker then examines the Protecting Venues List to determine the number of venues on the List (203).

If there is exactly one venue on the Protecting Venues List, the Venue Picker chooses that venue for the order (204).

If there is more than one venue on the Protecting Venues List, the Venue Picker applies one or more secondary criteria in order to choose a single venue from among those on the Protecting Venue List (205).

If there are no venues on the Protecting Venues List, the Venue Picker applies one or more secondary criteria in order to choose a single venue from among all venues on the Eligible Venues List (206). These criteria may be either the same as, or different from, the criteria used when there are multiple venues on the Protecting Venues List.

The Venue Picker may also be invoked in response to a change to the attributes of an existing order, in a fashion similar to that associated with a newly received order. This may occur in circumstances where a change to the order's attributes (share quantity, limit price, security, etc.) warrants a re-evaluation of the venue on which the order should be placed.

The PVLC and Venue Picker can either provide a one-time operation or a continuous processing operation. If Continuous processing is provided, an order is monitored over its lifetime to determine whether conditions have changed such that the order should be placed on a different venue. This includes circumstances where an order that was previously protected on a venue no longer is, where an order that previously could not be protected on any venue now can, and where an order that continues to be protected on its current venue can now also be protected on a different, more preferable venue.

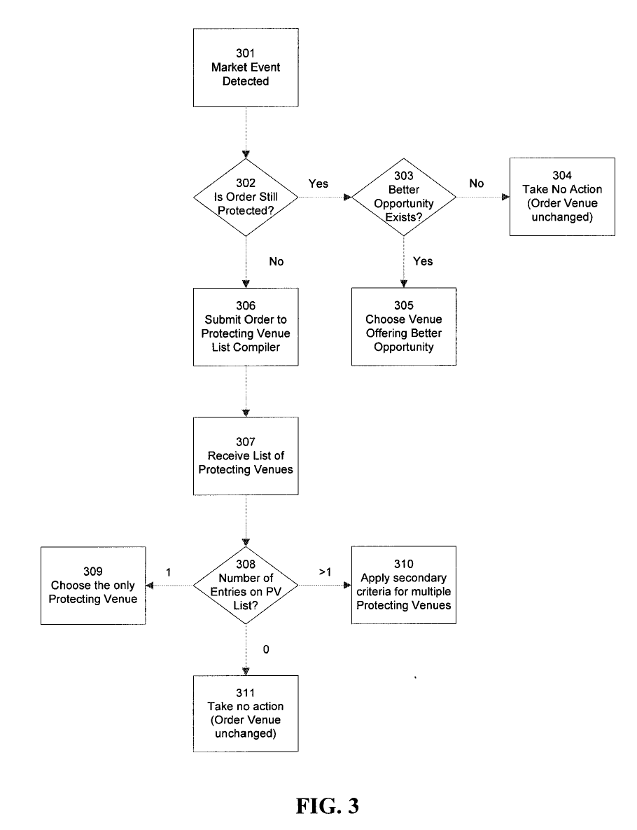

FIG. 3 shows an exemplary flowchart of Continuous Processing according to the exemplary embodiment. Continuous Processing monitors an order over its lifetime to identify circumstances where market conditions have changed such that an order should be moved from one venue to another. This Continuous Processing logic can be provided by software, but the invention is not limited in this respect.

In this exemplary embodiment, the Continuous Processing is concerned with monitoring an order that is currently protected in order to identify circumstances where the order comes to be no longer protected, as well as circumstances where an opportunity arises for the order to be protected on a different venue that is preferable to the order's current venue.

The Continuous Processing logic first detects market events that warrant a re-examination of the order to determine whether it should be moved from one venue to another (301).

In a simple example of the events being monitored, the Continuous Processing logic monitors the best bid or offer quotes (the bid quote if the order is to buy, the offer quote if the order is to sell) of the trading center associated with the venue on which an order currently resides, in order to identify a situation where an order that was previously protected from trade-through on its current venue is no longer protected. Changes to the price of the best bid or offer quote of the relevant trading venue, particularly in the case of an improving price (i.e. a bid that becomes higher or an offer that becomes lower), may indicate that the order is no longer protected.

There is additional complexity associated with determining whether an order remains protected when it resides on a venue that is associated with the ADF trading center. In these instances, changes to either the price or size (or both) of any ADF participant's quotation may cause an order that was previously protected to cease to be protected. Thus, in these cases, Continuous Processing logic would have to make a more complex assessment of a larger quantity of data.

Although only a few examples of market events that that warrant a re-examination of the order are discussed above, the invention is not limited to these examples and other market events could be used to determine that a re-examination is warranted. In addition, changes to the attributes of the order itself might prompt such a re-examination.

Having detected a market event that warrants further analysis, this Continuous Processing logic first determines whether an order is still protected on its current venue (302).

If the order is still protected, the Continuous Processing logic can still evaluate whether a better opportunity exists for the order on another venue (303). This assessment may apply many different criteria; a particular example would be an evaluation to determine whether the order could still be protected if it were moved to a venue that is ranked higher than the current venue on a list of venues ordered by preference. This circumstance most likely arises when the higher-ranking venue was originally bypassed because it did not offer protection at the time the order was originally evaluated.

If no better opportunity exists, no new venue is chosen for the order (304).

If a better opportunity does exist, then the venue offering the better opportunity is chosen as the new venue for the order (305).

If the order is no longer protected from trade through on its current venue, the Continuous Processing logic next determines whether the order can be protected on another venue. It does so by submitting the order to the PVLC (306).

As when it evaluates a new order, the PVLC returns a list of the venues offering protection (307).

The Continuous Processing logic then determines the number of entries on the Protecting Venue List (308).

If there is exactly one venue on the Protecting Venue List, this venue is chosen as the new venue for the order (309).

If there is more than one venue on the Protecting Venues List, the Venue Picker applies one or more secondary criteria in order to choose a single venue from among those on the Protecting Venue List. This venue is chosen as the new venue for the order (310).

If there are no venues on the Protecting Venues List, no new venue is chosen for the order (311).

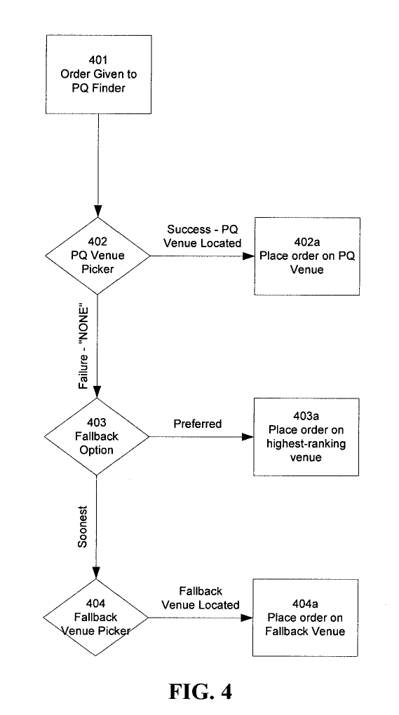

FIG. 4 is an exemplary flowchart illustrating another example of a Venue Picker with more specific secondary criteria. This Venue Picker uses a ranked list to choose among multiple venues offering quote protection, and offers two illustrative options for cases where no venues offer quote protection: one that uses a ranked list, and another that finds a venue where the order is expected to become protected soonest.

The specific, illustrative Venue Picker of this exemplary embodiment will be referred to hereafter as a Protected Quote Finder (PQF). The PQF of this exemplary embodiment allows a market participant to automatically and intuitively locate a market venue where a given limit order with a given limit price would be protected, and to place the limit order on that venue. In this exemplary embodiment, however, the secondary criteria used to ensure that a single market venue can be chosen for any order are defined more specifically.

Additional details of this initial evaluation of the PQF are described in detail below. First, the limit order is given to the PQF (401). The limit order may be given to the PQF either manually by a person who is managing that order or automatically by a rule-based order routing engine.

Once an order is given to the PQF, the Venue Picker of the PQF first evaluates whether any of the market venues on a preference list would offer the order protection from trade-through (402). This evaluation is similar to that made for each venue by the Protecting Venue List Compiler defined in an earlier exemplary embodiment herein. A market participant can establish the preference list, which is a ranked order of the participant's preferences among eligible market venues. Alternatively, if the market participant does not wish to establish the preference list, the PQF can provide a default preference list.

The preference list is a hierarchical, ranked list of market venues on which the participant wishes to place orders. The list is used to resolve ‘ties’ where two or more venues offer a given order the same advantage with respect to trade-through protection. Thus, the Venue Picker is always able to identify a single venue for any order for which multiple venues offer protection by choosing the venue among those offering protection that has the highest ranking on the preference list.

When choosing a venue from the preference list, the PQF also takes into account situations where a given venue may not be used to display an order in a given security (either because that security is not traded on that venue at all, or because the particular participant is not entitled to display orders in that security on that venue). In such a situation, the PQF will consider the venue in question ineligible for that order, and will exclude it from consideration.

Having identified a single venue offering the order quote protection, the PQF places the order on the chosen venue (402a).

If none of the market venues on the preference list offers a protected-quote opportunity for the limit order, the Venue Picker returns a value of “NONE” and forwards the limit order to the Fallback Option (403). This allows a venue to be selected for the order, even if no venues currently offer protection from trade-through. In such cases, participants are also afforded an opportunity to set the Fallback Option to a value of either Soonest or Preferred.

The Preferred option offers a simple method, whereby if the limit order would not be protected on any of the venues identified in the preference list, the limit order is simply placed on the Preferred venue, or highest-ranking venue in the preference list (403a).

Alternatively, the Fallback Venue Picker may be invoked to find the venue where a limit order is likely to become protected Soonest (404). To determine the venue where a limit order is likely to become protected soonest, the Fallback Venue Picker utilizes current depth-of-book data from each venue to determine the size of the spread, or gap, between the limit order's price and the price immediately superior on each venue. The Fallback Venue Picker then selects the venue where the size of the spread is largest (404a). In cases where the spread is of equal size on two or more venues, the highest-ranking of these venues, based on the preference list, is selected.

Venues for which sufficient depth-of-book data (through to at least the limit order's price) is not available are excluded from consideration by the Fallback Venue Picker. If the depth-of-book data is not available for any eligible venue, the Fallback Venue Picker will simply choose the highest-ranking venue on the preference list.

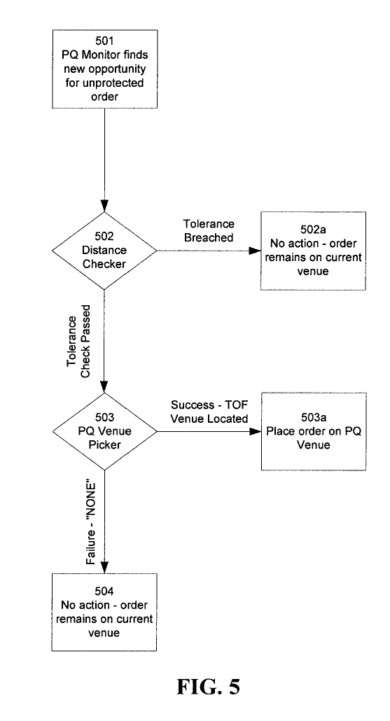

FIG. 5 is an exemplary flowchart illustrating a more specific example of Continuous Processing for the PQF of FIG. 4. This represents a more specific example of the type of Continuous Processing described with respect to a previous exemplary embodiment, and shown in FIG. 3.

This exemplary Continuous Processing option will be referred to hereafter as PQF Continuous Processing. The PQF Continuous Processing identifies circumstances where an order that is currently unprotected could be protected if moved to another venue. This illustrative processing also employs a Distance Checker to identify circumstances where an order's price is far enough away from the relevant stock's current trading price that the order's prospects for execution on any venue are minimal, and therefore the movement to a new venue should be inhibited.

Specifically, the PQF can provide the participant with a choice between one-time operation and continuous operation. Specifically, the participant can set a Continuous Processing value to either Yes or No. If the value is set to Yes, the PQF will operate in a continuous mode, such that the PQF Continuous Processing searches continuously after the initial evaluation for opportunities to move a currently unprotected limit order to a venue on which it would be protected. If the value is set to No, the PQF operates in a One-Time mode and no further evaluation is provided.

In the continuous mode, the PQF will continuously monitor the limit order for as long as it is active to ensure that the limit order is protected, or alternatively placed in a suitable market. For example, the limit order may have been protected at the time of initial evaluation but is not currently protected because it has been displaced by the arrival of a superior-priced order displayed in that same venue. Moreover, the limit order may not have been eligible to be protected on any venue at the time of its initial placement and, therefore, was placed on a non-protecting venue.

When a limit order is not currently protected and the Continuous Processing mode has been selected, a Protected Quote Monitor will continuously monitor the current trading price of the relevant stock/security. (501).

Specifically, a Distance Checker determines if a Continuous Processing Threshold has been reached; i.e., the limit order's price is so far away from the stock/security's trading price that modifying the placement of the limit order is not likely to be worthwhile (502). If the Continuous Processing Threshold is reached (i.e., tolerance breached), the modification of the limit order placement from one venue to another is inhibited (502a).

If, on the other hand, the Continuous Processing Threshold is not met (i.e., tolerance check passed), the placement of the limit order will be re-evaluated by the Venue Picker (503). That is, the Distance Checker determines that the limit order should be further considered for movement to a different venue.

Then, the Venue Picker reviews any changes to the market conditions and modifies the selection of market venue when appropriate. If there is a venue that can offer the limit order trade-through protection (Success-Venue Located), the Venue Picker places the limit order on that venue (503a); here, as for the PQF's initial evaluation described earlier and illustrated in FIG. 4, the highest-ranking venue is chosen when more than one venue offers protection. On the other hand, if the Protected Quote Venue Picker is unable to find a venue where the limit order will be protected (i.e., Failure-“None”), no affirmative action is taken and the limit order remains on its current venue (504).

The Continuous Processing Threshold may be expressed as, for example, a percentage of the stock's trading price, a multiple of the bid/offer spread for the stock, or an absolute number in cents. If the Continuous Processing Threshold is specified as a multiple of the bid/offer spread or as a percentage of the stock's trading price, the Distance Checker converts the Continuous Processing Threshold value to an absolute number of cents based on the stock's trading price. Then, the price of the limit order is compared to the inside price (the inside bid for buy orders and the inside offer for sell orders). If the distance, or spread, between the two prices exceeds the Continuous Processing Threshold (as converted to a number of cents), the limit order is left on its current venue (502a). If on the other hand, the distance between the two prices does not exceed the Continuous Processing Threshold, the limit order is evaluated by the Venue Picker for potential movement to a new venue (503).

When choosing a venue for an order, the PQF may also exclude certain venues from consideration for various reasons unrelated to trade-through protection. For example, the PQF may take into account situations where a given venue may not be used to display an order in a given security (either because that security is not traded on that venue at all, or because the particular participant is not entitled to display orders in that security on that venue). In such a situation, the PQF will consider the venue in question ineligible for that order, and will exclude it from consideration.

Certain venues, among them the NASDAQ Stock Market and the Archipelago Exchange, offer participants the ability to display orders on an attributed basis. That is, the orders can be displayed using a quote mnemonic that specifically identifies the market participant. The PQF allows participants to specify, for each venue offering this attributable order option, whether the option should be used.

While the present invention has been particularly shown and described with reference to exemplary embodiments thereof, it will be understood by those of ordinary skill in the art that various changes in forms and details may be made therein without departing from the spirit and scope of the present invention as defined by the following claims.

What is claimed is:

1. A method of automatically selecting a market venue for a limit order, comprising:
identifying which of a plurality of market venues on a list of potential routing destinations would offer the order protection from trade-through.

2. The method according to claim 1, further comprising:
if at least one of the market venues would offer the order protection from trade-through, placing the order on a protecting market venue.

3. The method according to claim 1, further comprising:
if at least two of the market venues would offer the order protection from trade-through, selecting a protecting market venue, from among the market venues that would offer the order protection from trade-through, based on one or more criteria.

4. The method according to claim 3, further comprising:
placing the order on the selected protecting market venue.

5. The method according to claim 3, wherein the market venues to which the participant wishes to place the limit order are ranked, and the selected protecting market venue is a highest ranked protecting market venue.

6. The method according to claim 1, further comprising:
if exactly one of the market venues would offer the order protection from trade-through, selecting that protecting market venue.

7. The method according to claim 6, further comprising:
placing the order on the selected protecting market venue.

8. The method according to claim 1, further comprising:
if none of the market venues would offer the order protection from trade-through, selecting a non-protecting market venue from the list of potential routing destinations based on one or more criteria.

9. The method according to claim 8, further comprising:
placing the order on the selected non-protecting market venue.

10. The method according to claim 8, wherein the market venues to which the participant wishes to place orders are ranked, and the selected non-protecting market venue is a highest ranked non-protecting market venue.

11. The method according to claim 8, wherein the selected non-protecting market venue is a market venue where the order is predicted to be protected soonest.

12. The method according to claim 2, further comprising continuously monitoring a placement of the order based on changing market conditions.

13. The method according to claim 12, further comprising moving the order from the market venue on which the order has been placed to another market venue if the market venue on which the order has been placed has ceased to be a most favorable venue for the order, with respect to trade-through protection.

14. The method according to claim 4, further comprising continuously monitoring a placement of the order based on changing market conditions.

15. The method according to claim 14, further comprising detecting a circumstance where the order is no longer protected.

16. The method according to claim 15, further comprising determining whether one or more other venues offers protection to the order.

17. The method according to claim 16, further comprising moving the order to a new venue offering protection.

18. The method according to claim 14, further comprising detecting a circumstance where the order can also be protected on a higher-ranking market venue.

19. The method according to claim 18, further comprising moving the order to a higher-ranking market venue also offering protection.

20. The method according to claim 7, further comprising continuously monitoring a placement of the order based on changing market conditions.

21. The method according to claim 20, further comprising detection of a circumstance where the order, which has been placed on the selected protecting market, is no longer protected.

22. The method according to claim 21, further comprising determining whether one or more other market venues offers protection to the order.

23. The method according to claim 22, further comprising moving the order to a new market venue offering protection.

24. The method according to claim 20, further comprising detecting a circumstance where the order can also be protected on a higher-ranking market venue.

25. The method according to claim 24, further comprising moving the order to the higher-ranking venue also offering protection.

26. The method according to claim 9, further comprising continuously monitoring a placement of the order based on changing market conditions.

27. The method according to claim 26, further comprising detecting a circumstance where an order, which has been placed on the selected non-protecting market venue, can now be protected if moved to a different market venue.

28. The method according to claim 27, further comprising moving the order to a new market venue offering protection.

29. A computer readable medium provided with instructions for automatically selecting a market venue for a limit order, the instructions comprising:
identifying which of a plurality of market venues on a list of potential routing destinations would offer the order protection from trade-through.

30. The computer readable medium to claim 29, wherein the instructions further comprise:
if at least one of the market venues would offer the order protection from trade-through, placing the order on a protecting market venue.

31. The computer readable medium to claim 29, wherein the instructions further comprise:
if at least two of the market venues would offer the order protection from trade-through, selecting a protecting market venue, from among the market venues that would offer the order protection from trade-through, based on one or more criteria.

32. The computer readable medium according to claim 31, wherein the instructions further comprise:
placing the order on the selected protecting market venue.

33. The computer readable medium according to claim 31, wherein the market venues to which the participant wishes to place the limit order are ranked, and the selected protecting market venue is a highest ranked protecting market venue.

34. The computer readable medium according to claim 29, wherein the instructions further comprise:
if exactly one of the market venues would offer the order protection from trade-through, selecting that protecting market venue.

35. The computer readable medium according to claim 34, wherein the instructions further comprise:
placing the order on the selected protecting market venue.

36. The computer readable medium according to claim 29, wherein the instructions further comprise:
if none of the market venues would offer the order protection from trade-through, selecting a non-protecting market venue from the list of potential routing destinations based on one or more criteria.

37. The computer readable medium according to claim 36, wherein the instructions further comprise:
placing the order on the selected non-protecting market venue.

38. The computer readable medium according to claim 36, wherein the market venues to which the participant wishes to place orders are ranked, and the selected non-protecting market venue is a highest ranked non-protecting market venue.

39. The computer readable medium according to claim 36, wherein the selected non-protecting market venue is a market venue where the order is predicted to be protected soonest.

40. The computer readable medium according to claim 30, further comprising continuously monitoring a placement of the order based on changing market conditions.

41. The computer readable medium according to claim 40, wherein the instructions further comprise moving the order from the market venue on which the order has been placed to another market venue if the market venue on which the order has been placed has ceased to be a most favorable venue for the order, with respect to trade-through protection.

42. The computer readable medium according to claim 32, wherein the instructions further comprise continuously monitoring a placement of the order based on changing market conditions.

43. The computer readable medium according to claim 42, wherein the instructions further comprise detecting a circumstance where the order is no longer protected.

44. The computer readable medium according to claim 43, wherein the instructions further comprise determining whether one or more other venues offers protection to the order.

45. The computer readable medium according to claim 44, wherein the instructions further comprise moving the order to a new venue offering protection.

46. The computer readable medium according to claim 42, wherein the instructions further comprise detecting a circumstance where the order can also be protected on a higher-ranking market venue.

47. The computer readable medium according to claim 46, wherein the instructions further comprise moving the order to a higher-ranking market venue also offering protection.

48. The computer readable medium according to claim 35, wherein the instructions further comprise continuously monitoring a placement of the order based on changing market conditions.

49. The computer readable medium according to claim 48, wherein the instructions further comprise detection of a circumstance where the order, which has been placed on the selected protecting market, is no longer protected.

50. The computer readable medium according to claim 49, wherein the instructions further comprise determining whether one or more other market venues offers protection to the order.

51. The computer readable medium according to claim 50, wherein the instructions further comprise moving the order to a new market venue offering protection.

52. The computer readable medium according to claim 48, wherein the instructions further comprise detecting a circumstance where the order can also be protected on a higher-ranking market venue.

53. The computer readable medium according to claim 52, wherein the instructions further comprise moving the order to the higher-ranking venue also offering protection.

54. The computer readable medium according to claim 37, wherein the instructions further comprise continuously monitoring a placement of the order based on changing market conditions.

55. The computer readable medium according to claim 54, wherein the instructions further comprise detecting a circumstance where an order, which has been placed on the selected non-protecting market venue, can now be protected if moved to a different market venue.

56. The computer readable medium according to claim 55, wherein the instructions further comprise moving the order to a new market venue offering protection.
